(19) United States
(12) Patent Application Publication
(10) Pub. No.: US 2006/0290666 A1
(43) Pub. Date: Dec. 28, 2006

(54) Method and device for assisting searching for an item in a list by accelerated scrolling on a display device

(75) Inventor: Henri Crohas, Verrieres-Le-Buisson (FR)

Correspondence Address: BROWDY AND NEIMARK, P.L.L.C.;624 NINTH STREET, NW, SUITE 300, WASHINGTON, DC, 20001-5303, US

(73) Assignee: Societe Anonyme Archos, Igny (FR)

(21) Appl. No.: 11/194,728

(22) Filed: Aug. 2, 2005

(30) Foreign Application Priority Data
Jun. 27, 2005 (FR) 0506520

(51) Int. Cl. G09G 5/08

(52) U.S. Cl. 345/157

(57) ABSTRACT

This method of scrolling a list of items on a display device of a multimedia device consists in accelerating the scrolling of the list or browsing within a multimedia content (14; 18; 22; 26) by actuating (12; 16; 20; 24) one or more buttons of the device.

The present invention relates to a method and device for assisting searching for an item in a list by accelerated scrolling on a display device.

Portable and fixed multimedia devices generally include buttons for controlling their operation. The commonest control arrangement consists of five buttons labeled “UP”, “DOWN”, “LEFT”, “RIGHT” and “OK”, together with other buttons that may vary from one device to another.

The above five buttons are generally disposed in the form of a control “star” with four branches formed by the upward, downward, leftward and rightward directions, the “OK” button being either in the middle of the star or elsewhere on the device.

The buttons of the control star are used to control a great variety of functions which include, in the case of multimedia contents:
selection of the multimedia content (files containing text, music, video clips, photos, etc.) that the user wishes to play or display;
during reproduction of the content, control of the volume using the “UP” and “DOWN” buttons;
during reproduction of the content, controlling reproduction using the “LEFT” and “RIGHT” buttons to access the preceding or next track, video clip or photo, or to control the position within the track, for example fast forward or fast rewind, or to select the portion of the content to be viewed.

In multimedia devices, the quantity of content offered may be considerable: there may be hundreds of videos, thousands of songs and tens of thousands of images that may be consulted on the device. If the user wishes to select a content from a wide choice of contents, it is hardly practical to do so using the control star referred to above. As the content is usually displayed in the form of a list on a screen, to see all of the content and make a choice the user is obliged to press repeatedly the “UP” and “DOWN” buttons (or the “LEFT” and “RIGHT” buttons, depending on the user interface of the device). The list may take the form of text or thumbnails of photos or video clips disposed in rows or in the form of an array on the screen.

Techniques are known in the art that enable the user to select and find rapidly the content for which he is searching, such as a repeat function that is effected automatically when the user holds down a control button. The device then automatically scrolls through the list at a certain speed, so that the user does not need to press the button repeatedly himself. It is also known in the art to have the speed of the repetition function increase as a function of time, so that a content situated farther away in the list can be reached in a limited time, regardless of the number of items in the list.

The same operation of holding a button down is also used to browse within content tracks. For example, to distinguish a “previous/next track” command from a “fast rewind/fast forward” command, it is known in the art to provide for pressing the “LEFT” or “RIGHT” button once to command a change to the previous or next content track, while holding down the same button commands movement within the track.

Other control means on multimedia devices are also known in the art, such as a thumbwheel or a touch strip. By turning the thumbwheel with the thumb or the index finger, the user can select entries from a list or adjust the volume or other parameters, depending on the context of the device. A touch strip also enables entries to be selected by moving the finger up or down along its surface, and the speed at which the finger moves may be used to determine the point of advance in the list.

All the above prior art techniques have drawbacks.

Although the operation and the use of the control star are very easy, a problem arises if the device offers a great quantity of contents or if the tracks that are executed are themselves large. The repeat or acceleration actions referred to above can improve the consultation of the contents, but problems remain, for example:
a fixed repetition speed helps to find a content that is relatively close to the current selection, but makes it more difficult to access a content that is farther away, as it takes a long time to get there;
accelerated repetition helps to access a content that is farther away, but when scrolling at high speed the user finds it difficult to release the button at the precise moment he sees the required content appear on the screen, so that there is often an overshoot, followed by a reverse movement;
the display screens usually employed in multimedia devices are relatively small and are able to display only a few items from the list at a time; moreover, the screens are relatively slow, which means that refreshing them at high speed during an accelerated repetition command may lead to a fuzzy display that makes it difficult to view the content and prevents the user releasing the button at the right time.

An object of the invention is to remedy the drawbacks cited above.

To this end, the present invention proposes a method of scrolling a list of items on a display device of a multimedia device, noteworthy in that it consists in accelerating the scrolling of the list or browsing within a multimedia content by actuating one or more buttons of the device.

Thus the invention enables the user, by means of a very simple maneuver, to access more quickly a content in a list of items, even a long list, that is scrolling on the screen of a multimedia device, or to access a given portion of a content of a track, even if the latter portion is a long way from the start of the track.

According to one particular feature, pressing a button known as an accelerator button once moves the display of the list forward or backward by one page, a page representing the maximum number of items from the list that can be displayed simultaneously on the display device. This makes it very simple to advance page by page.

According to one particular feature, holding down said button moves the display of the list forward or backward repetitively page by page. This avoids the user pressing the button repeatedly to change page.

According to one particular feature, the repetition rate increases as a function of time. Advancing through the list is therefore much faster, which is particularly advantageous if the list is long and the content to which the user requires access is far away in the list.

According to one particular feature, if a number p of items from the list can be displayed simultaneously on said display device, when said button is held down, the repetition rate increases as a function of time and, when a predetermined scrolling speed is reached, only one in every p items from the list is displayed. This avoids the list becoming unreadable if the repetition rate becomes too high. The refreshing of the display appears slower, which is more visually comfortable for the user, in addition to the speed of scrolling the list.

A variant of this way of “compressing” a list is particularly advantageous if the list is very long. If the list comprises N items and a number p of items from the list can be displayed simultaneously on said display device, if the accelerator button is held down, there are displayed on a first page p items spaced from each other by N/p items, successive iterations follow until the item searched for is reached, each iteration consisting in displaying on a page p items at a distance of N′/p items from each other, N′ being the total number of items from a sub-list containing the items searched for, consisting of items between the item s×(N′/p) currently selected and the next item (s+1)×(N′/p), s being a strictly positive integer.

According to one particular feature, when browsing within a content, pressing an accelerator button once causes a forward movement or a backward movement of a certain time or of a certain quantity of text within the content. This provides a very simple way to accelerate browsing within a track.

According to one particular feature, when browsing within a content, holding said button down moves forward or backward repetitively a certain time or a certain quantity of text within the content. This accelerates browsing within a track without the user having to press the accelerator button repeatedly.

As for scrolling through a list, for browsing within a track, the repetition rate increases as a function of time.

With the same aim as indicated above, the present invention further proposes a device for scrolling a list of items on a display device of a multimedia device, noteworthy in that it includes at least one button whose actuation accelerates the scrolling of the list or browsing within a multimedia content.

The particular features and advantages of the device being similar to those of the method, they are not repeated here.

Other aspects and advantages of the invention will become apparent on reading the following detailed description of particular embodiments, provided by way of non-limiting example. The description refers to the accompanying drawings, in which:

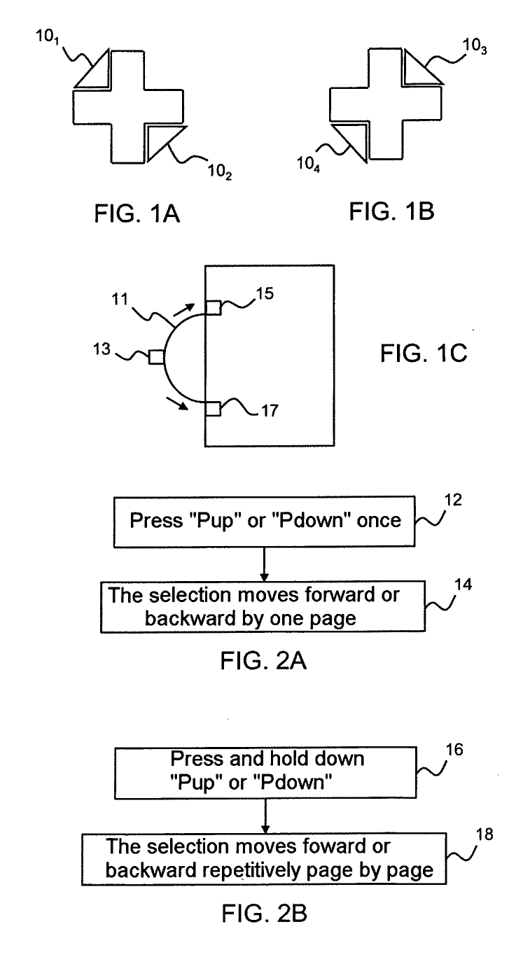

FIGS. 1A, 1B and 1C show three particular embodiments of an arrangement of accelerator buttons adapted to implement an accelerated scrolling method of the present invention; and

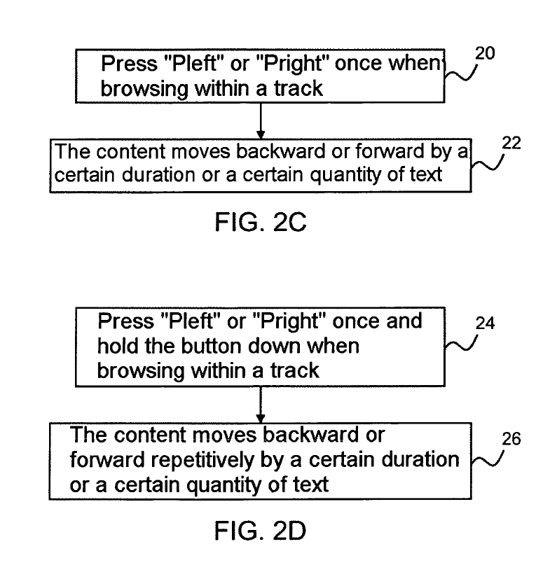

FIGS. 2A, 2B, 2C and 2D are flowcharts showing applications of the accelerated scrolling method of the present invention in particular embodiments thereof.

The remaining description considers a multimedia device provided with at least one display device and which is controlled by actuating buttons, the term “button” being understood here in the widest sense and including touch-sensitive control means.

In one particular embodiment, the accelerated scrolling method of the present invention is implemented by actuating two additional buttons, referred to as accelerator buttons, that are provided in addition to the conventional control star referred to in the introduction.

By way of non-limiting example, the accelerator buttons may be placed in the “corners” of the control star, opposite each other along a diagonal, i.e. top-left and bottom-right, as shown by the buttons 10₁ and 10₂ in FIG. 1A, or bottom-left and top-right, as shown by the buttons 10₃ and 10₄ in FIG. 1B.

Note that the shape of these buttons selected to depict them in the figures is merely one non-limiting example.

Also, only two accelerator buttons are shown. However, two more may be provided in the free corners of the control star. For example, acceleration functions may be provided at one and the same time for up-down type selection in a list and for forward-backward (or left-right) selection when browsing within a multimedia content.

Moreover, the accelerator buttons are not necessarily separate keys. A single control star may be provided that may be actuated not only at four locations corresponding to the directions north, south, east and west but also at other locations on two diagonals (north-west, south-east, north-east, south-west). All actuation possibilities are then combined on a one-piece button.

Moreover, as mentioned above, the accelerator buttons are not limited to controlling horizontal selection actions or vertical selection actions. They may be used to control both types of selection action, the selection direction depending on the operating context of the multimedia device concerned. In the remainder of the description, these additional buttons are designated “Pup” and “Pdown” when they are used for up-down selection and “Pleft” and “Pright” when they are used for left-right selection.

FIG. 1C shows another particular embodiment of an arrangement of accelerator buttons adapted to implement an accelerated scrolling method of the present invention, in the form of a thumbwheel mechanism 11 on one side of the terminal.

The thumbwheel has three buttons: a central selector button 13 and two buttons 15 and 17 which when actuated respectively trigger the functions of access to the next page (“Pup”) and the previous page (“Pdown”) of a list and enable accelerated scrolling of a list, respectively in the forward or backward direction, when they are held down.

This embodiment using a thumbwheel is obviously not the only one that is feasible and many variants within the ordinary general knowledge of the person skilled in the art may be envisaged.

The accelerator buttons assist the user in various ways during selection and browsing, as follows:
when selecting from a list of items, simply pressing the “Pup” button, respectively the “Pdown” button (see step 12 in FIG. 2A), moves the selection forward, respectively backward, by a complete page, a page consisting of a number p of items that can be displayed simultaneously on the screen of the multimedia device (step 14);
if the user holds down the “Pup” button, respectively the “Pdown” button (see step 16 in FIG. 2B), the device repeats the operation of moving forward or moving backward by one page (step 18) so that the list moves page by page; the repetition rate may accelerate as a function of time, to facilitate access to contents farther away in the list;
when the user is browsing inside a track containing sound or video, simply pressing the “Pleft” button, respectively “Pright” button (see step 20 in FIG. 2C) moves the content backward, respectively forward, by a certain time (step 22) which may be predetermined, enabling the user to scroll the content more easily; if the content consists of text divided into sections or chapters, pressing “Pleft”, respectively “Pright”, moves the text backward or forward by one section or one chapter, for example;
when the user is browsing inside a track, if he holds down the “Pleft” button, respectively the “Pright” button, (step 24 in FIG. 2D), the device repeats the operation of moving forward or backward in the content (step 26); the repetition rate may also accelerate as a function of time, to facilitate access to portions of the content that are farther away.

If the user executes the step 16 in FIG. 2B and the repetition rate increases as a function of time, the accelerated scrolling method of the present invention “compresses” the list to make it easier for the user the read it when it is scrolling at a speed that is too high for the user to be able to see all of the items.

In accordance with the present invention, starting from a predetermined scrolling speed, the device does not display all of the items from the list, but only one item every p items, where p is a predetermined integer. Each page (in the sense defined above) containing p items, the list displayed contains only one item from each page.

When the user releases the accelerator button, the compression of the list ceases and the user sees a display of the whole of the part of the list situated around the item currently selected.

At the time of the transition between the normal scrolling state and the scrolling state with compression, the items of the list preceding the item currently selected are displayed normally, i.e. one by one without omitting any; only the items from the list following the item currently selected are displayed every p items. At this stage all the items that have been displayed one by one have left the screen of the display device and the user sees only one item every p items.

The items included in the compressed list portion may be represented differently than those from the list displayed normally. For example, they may appear in a different color or a different font or with a different indentation or a different icon, which assists the user to notice that the list has changed to a compressed scrolling mode.

A non-limiting example of this follows.
List before compression (size of page: p=5):
item n−2
item n−1
selected item n
item n+1
item n+2
List scrolling down in the compressed state:
item n−2 (normal)
item n−1 (normal)
selected item n
item n+p (compressed)
item n+2p (compressed)

List moved by x pages in the compressed state, as far as the item m=n+xp:
item m−2p
item m−p
selected item m
item m+p
item m+2p

List reverting to normal scrolling:
item m−2
item m−1
selected item m
item m+1
item m+2

According to the present invention, another feasible list compression technique is particularly advantageous if the list is very long.

This technique consists in searching the list iteratively, by displaying on each page p items separated from each other by a number of items calculated as follows. Let N be the total number of items in the list. There are displayed first of all:
item 1
item N/p
item 2×(N/p)
. . .
item N

Then, if the item currently selected is the item s×(N/p) from the compressed list that precedes the element searched for, s being a positive integer, on the first iteration, compression is applied in a similar manner to all of the items between the item s×(N/p) and the next item (s+1)×(N/p). The process continues in this way by successive iterations until the item searched for is found.

When scrolling the list in compressed form, the user sees the display refreshed more slowly and it is therefore easier for him to see where he is in the list, even though not all the items thereof are visible. For example, in a list sorted by alphabetical order, he sees the first letters of the items displayed and is able to decide when to release the accelerator button to access an item that is in the portion of the alphabet currently displayed.

This list compression option does not apply only to lists of text content that move vertically. It may equally be applied to a list of photographs disposed horizontally and sorted by the date on which they were taken, for example. In this case, compression may consist in displaying only photographs for which the date it was taken are in a predetermined period, which amounts to displaying only one photo every p photos.

1. Method of scrolling a list of items on a display device of a multimedia device, characterized in that it consists in accelerating the scrolling of the list or browsing within a multimedia content (14; 18; 22; 26) by actuating (12; 16; 20; 24) one or more buttons (10₁, 10₂; 10₃, 10₄) of the device.

2. Method according to claim 1, characterized in that pressing (12) said button once moves the display of the list forward or backward (14) by one page.

3. Method according to claim 1, characterized in that holding down said button (16) moves the display of the list forward or backward (18) repetitively page by page.

4. Method according to claim 3, characterized in that the repetition rate increases as a function of time.

5. Method according to claim 4, wherein a number p of items from the list can be displayed simultaneously on said display device, said method being characterized in that, when said button is held down, the repetition rate increases as a function of time and, when a predetermined scrolling speed is reached, only one in every p items from the list is displayed.

6. Method according to claim 1, wherein the list comprises N items and a number p of items from the list can be displayed simultaneously on said display device, said method being characterized in that, if said button is held down, there are displayed on a first page p items spaced from each other by N/p items, successive iterations follow until the item searched for is reached, each iteration consisting in displaying on a page p items at a distance of N′/p items from each other, N′ being the total number of items in a sub-list containing the items searched for, consisting of items between the item s×(N′/p) currently selected and the next item (s+1)×(N′/p), s being a strictly positive integer.

7. Method according to claim 1, characterized in that, when browsing within a content, pressing said button once (20) causes a forward movement or a backward movement (22) of a certain time or of a certain quantity of text within the content.

8. Method according to claim 7, characterized in that, when browsing within a content, holding said button down (24) moves forward or backward (26) repetitively a certain time or a certain quantity of text within the content.

9. Method according to claim 8, characterized in that the repetition rate increases as a function of time.

10. A device for scrolling a list of items on a display device of a multimedia device, characterized in that it includes one or more buttons (10₁, 10₂; 10₃, 10₄) whose actuation accelerates the scrolling of the list or browsing within a multimedia content.

11. Device according to claim 10, characterized in that said button is adapted to move the display of the list forward or backward (14) by one page when it is pressed once (12).

12. Device according to claim 10, characterized in that said button is adapted to move the display of the list forward or backward (18) repetitively page by page when it is held down (16).

13. Device according to claim 12, characterized in that the repetition rate increases as a function of time.

14. Device according to claim 13, wherein a number p of items from the list can be displayed simultaneously on said display device, said device being characterized in that the repetition rate increases as a function of time if said button is held down and said device is adapted to display only one item in every p items from the list when a predetermined scrolling speed is reached.

15. Device according to claim 10, wherein the list comprises N items and a number p of items from the list can be displayed simultaneously on said display device, said device being characterized in that, if said button is held down, it is adapted to display on a first page p items separated from each other by N/p items, and then to proceed by successive iterations until the item searched for is reached, each iteration consisting in displaying on a page p items separated from each other by N′/p items, N′ being the total number of items in a sub-list containing the item searched for, consisting of items between the item s×(N′/p) currently selected and the next item (s+1)×(N′/p), s being a strictly positive integer.

16. Device according to claim 10, characterized in that, when browsing within a content, said button is adapted to move forward or backward (22) within the content by a certain time or a certain quantity of text when it is pressed once (20).

17. Device according to claim 16, characterized in that, when browsing within a content, said button is adapted to move repetitively forward or backward (26) within the content by a certain time or a certain quantity of text when it is held down (24).

18. Device according to claim 17, characterized in that the repetition rate increases as a function of time.

19. Method according to claim 2, characterized in that holding down said button (16) moves the display of the list forward or backward (18) repetitively page by page.

20. Device according to claim 14, wherein the list comprises N items and a number p of items from the list can be displayed simultaneously on said display device, said device being characterized in that, if said button is held down, it is adapted to display on a first page p items separated from each other by N/p items, and then to proceed by successive iterations until the item searched for is reached, each iteration consisting in displaying on a page p items separated from each other by N′/p items, N′ being the total number of items in a sub-list containing the item searched for, consisting of items between the item s×(N′/p) currently selected and the next item (s+1)×(N′/p), s being a strictly positive integer.
